(19) United States
(12) Patent Application Publication
(10) Pub. No.: US 2012/0320237 A1
(43) Pub. Date: Dec. 20, 2012

(54) Camera with function of removing unwanted object and method thereof

(76) Inventors: Wei-Ting Liu, Hacienda Heights, CA (US); Wei-Hua Lu, Taipei (TW); Chih-Kuei Hu, Jubei (TW)

(21) Appl. No.: 13/160,563

(22) Filed: Jun. 15, 2011

(51) Int. Cl. H04N 5/262

(52) U.S. Cl. 348/239; 348/E05.051

(57) ABSTRACT

The present invention discloses a photo processing method of a digital camera, including capturing a plurality of photos of a scene; comparing the photos to identify a moving part of the photos; choosing one of the plurality of photos as a source photo, replacing the moving part of the source photo according to a non-moving part of at least one of the photos; and outputting the modified source photo.

### BACKGROUND OF THE INVENTION

1. Field of the Invention

The present invention relates to a camera, and more particularly, to a camera with a function of removing unwanted object in a photo.

2. Description of the Prior Art

As the technology improvement of CMOS sensor and CCD sensor, digital camera is very popular in modern life. People bring digital camera to take photos in many occasions. In some public places, not in a private enclosure, taking photo without other strangers being taken into the photo is hard. As shown in FIG. 1, when a user wants to take a photo for his friend A with the famous tower for the background, it's hard to avoid stranger B walking through since the plaza in front of the famous tower is full of visitors. The unwanted object (stranger B) is shown in the photo when the user sees the photo again. How to take a photo without unwanted object is highly demanded.

### SUMMARY OF THE INVENTION

It is therefore a primary objective of the claimed invention to provide a method and a digital camera utilize the method for processing an image by removing an unwanted object in the image.

According to an objective of the present invention, the present invention discloses a photo processing method of a digital camera, comprising capturing a plurality of photos of a scene; comparing the photos to identify a moving part of the photos; choosing one of the plurality of photos as a source photo, replacing the moving part of the source photo according to a non-moving part of at least one of the photos; and outputting the modified source photo.

The present invention also discloses a photo processing method of a digital camera, comprising capturing a source photo of a scene; identifying a plurality of regions of the source photo, each region corresponding to an object of the scene; selecting an unwanted region by a user; and replacing the unwanted region by an image.

The present invention further discloses a digital camera for capturing a photo with removing unwanted object in the photo, comprising a lenses and image sensor module, for capturing a plurality of photos; a memory, for storing the plurality of photos; a controller, for removing unwanted object in one of the plurality of photos, wherein, the controller compares the plurality of photos, identifies a moving part of the plurality of photos, chooses one of the plurality of photos as a source photo, removes the moving part of the photo and replaces the moving part by a non-moving part of other photo, and outputs the modified source photo.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a photo taken by a user.

FIG. 2 is an ideal photo in user's mind.

FIG. 3 is a photo utilized for removing unwanted object.

FIG. 4 is a photo illustrating an overlapping area of a unwanted object.

FIG. 5 is a photo taken by a user.

FIG. 6 is a photo utilized for removing unwanted object.

FIG. 7 is a schematic diagram of a camera with removing unwanted object function according to present invention.

FIG. 8 is a flowchart of removing unwanted object of present invention.

### DETAILED DESCRIPTION

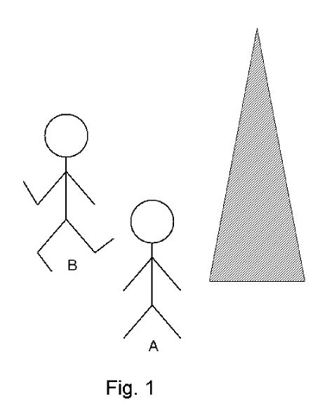

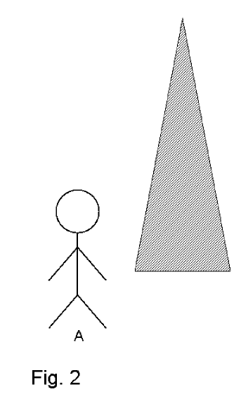

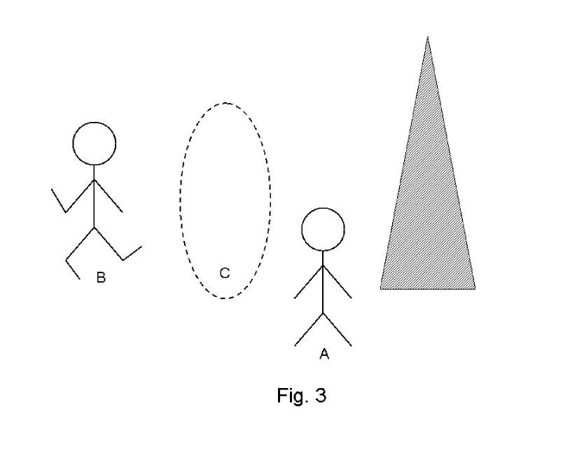

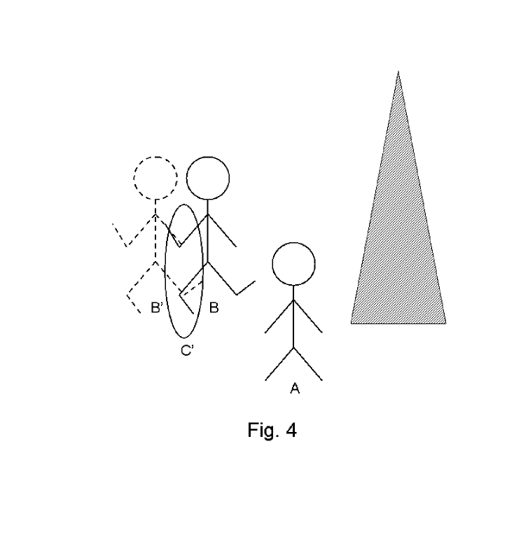

In order to take a photo without unwanted objects, such as a walking stranger, a moving vehicle etc, this invention provides solutions for removing the unwanted object. As shown in FIG. 1, when the user wants to take a photo for his friend A with the famous tower for background, a stranger B walking through the plaza in front of the famous tower is also being taken into the photo. So the photo took by the user is shown in FIG. 1, but the photo what the user wants is shown in FIG. 2. In FIG. 2, the photo is clean only with the user's friend A and the famous tower without the unwanted object (stranger B). In order to have a photo likes FIG. 2, one method is taking at least two consecutive photos for the scene. The second photo is shown in FIG. 3. The stranger B is farther from the friend A than that in FIG. 1.

Some well-known algorithms for photo can identify the object from the background theme; such as increases the sharpness, identify the contour etc. After the above process, the friend A and the stranger B are identified. Comparing the photos of FIG. 1 and FIG. 3, the stranger B had changed his position, and stranger B will be defined as a moving part of the photos. When a camera defines whether an object is belonging to the moving part of a photo, some situation should be excluded. For example, the scene may shake when the user pressed the shooting button, the friend A may slightly move or swing between the photos. These kinds of slightly movements will be ignored such that the friend A is defined as a non-moving part. That is the non-moving part of the photos is a relatively steady part of the photos. Furthermore, in a preferred embodiment, the camera can set a threshold for defining how much movement counts for defining a part as a moving part, and the others having a movement less than the threshold are defined as non-moving parts. Besides, user can define a subset region of a moving part or a non-moving part of an object by using cursor or touch a screen of the digital camera if the screen is a touch sensing screen. The digital camera can interfere to help the user define the contour of the region more precisely. It means, an object located within the user-defined region can be regarded as a subset of a moving part or a non-moving part. In this way, the user-defined region can then be replaced/never replaced according to the property (moving part or non-moving part) according to the user's demands.

After defining the moving part and non-moving part of the photos, the camera will pick one of these photos as a source photo. The source photo picking process may depend on the clearness of photo, user's choice or arbitrariness. For instance, FIG. 1 is taken as a source photo. All the non-moving part of FIG. 1 will remain and the moving part will be replaced. In order to replace the moving part of FIG. 1, the camera will get information (dashed oval zone C) from FIG. 3 to fill the removed moving part of FIG. 1 on a corresponding position of the scene. After above process, a clean photo without stranger B like FIG. 2 is obtained.

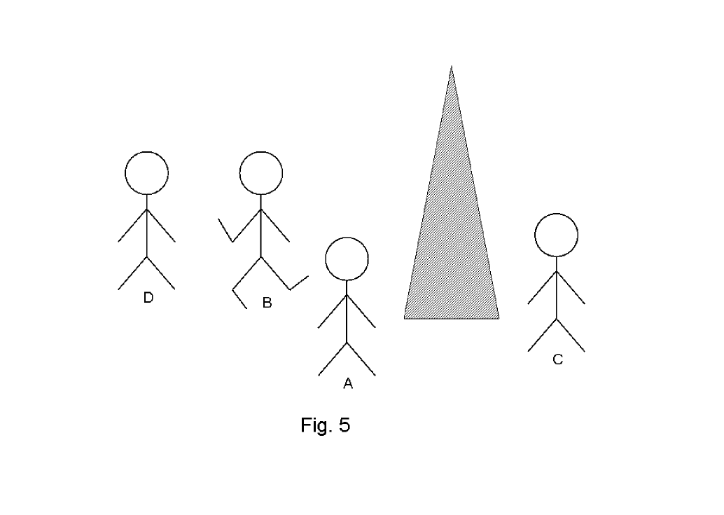

If stranger B walked slowly when taking two consecutive photos, the stranger B may overlap between these two photos as shown in FIG. 4. In FIG. 4, the oval zone C′ is covered by stranger B in both photos, so it's hard to retrieve a replacement background by utilizing these two photos. In this case, the oval zone C′ can be replaced by interpolating surrounding background according to surrounding position of oval zone C′, duplicating surrounding background or taking third or fourth consecutive photos (stranger B may move farther to clear up the overlap zone C′). In addition, the oval zone C′ can also be replaced by a mix with both the surrounding background and a non-moving part of another photo. The user can also extend the time period between photos, which will allow the stranger B to move farther.

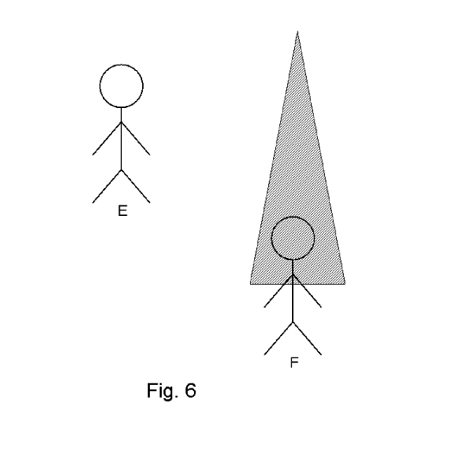

For removing unwanted objects, friend A may not need to stand in front of the camera too long. After taking a source photo shows in FIG. 5, user can use cursor or touch the photo display screen if the screen is touch sensing screen to identify which moving object is the unwanted object, and the selected object will be put to a subset of moving part. On the other hands, the user can select wanted objects, also. In this case, user can identify stranger B, stranger C and stranger D as unwanted moving objects. The camera will take another photo as shown in FIG. 6, and the photo in FIG. 6 may contain different strangers, stranger E and stranger F. The camera will utilize FIG. 6 to get background information to replace the unwanted moving objects in FIG. 5, or utilize surrounding background information to replace the unwanted moving objects in FIG. 4. Of course, we can identify the wanted moving object instead, and camera will remove the unwanted moving object accordingly.

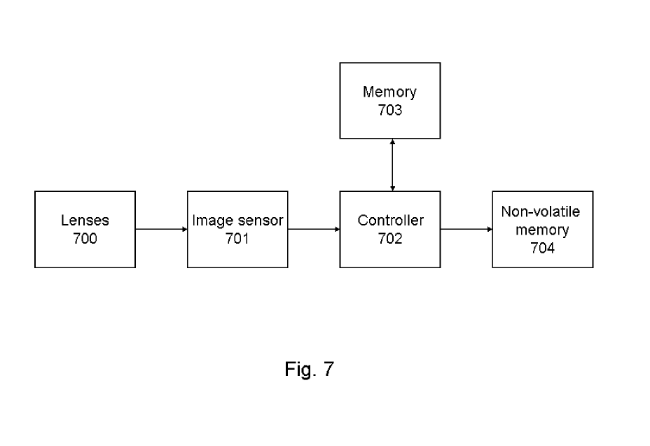

FIG. 7 shows a function diagram of a digital camera. Light passes through lenses 700. The photos are sensed by a photo sensor 701, and the photo sensor 701 converts the optical signals into electrical signals. The electrical signals could be analog signals. The electrical signals send to a controller 702 and the controller 702 receives the electrical signals. If the electrical signals are analog signals, the controller 702 will convert the analog signals into digital signals. The digital signals of the photos will store in the memory 703. The controller 702 compares the digital signals of the photos stored in the memory 703, identifies the moving part of the photos. The controller 702 selects one of the photos as a source photo, identifies an unwanted moving part of the source photo according to automatical decision or user's selection, replaces the unwanted moving part by using a background information of another photo of similar position or by using a surrounding background information. The controller 702 outputs the modified photo to a non-volatile memory 704.

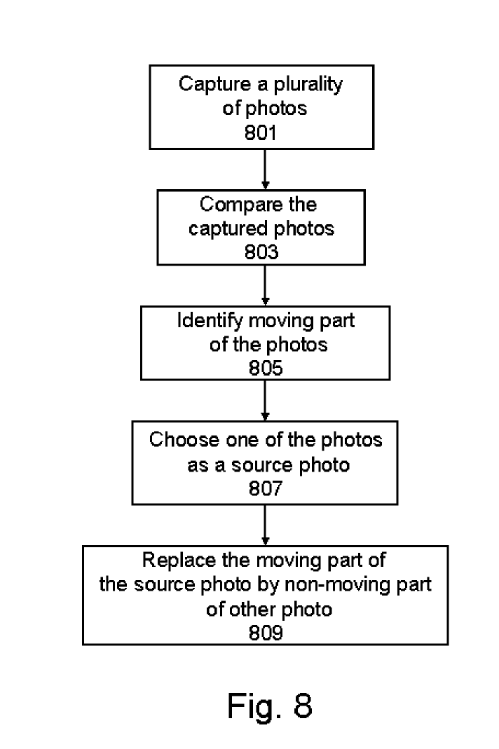

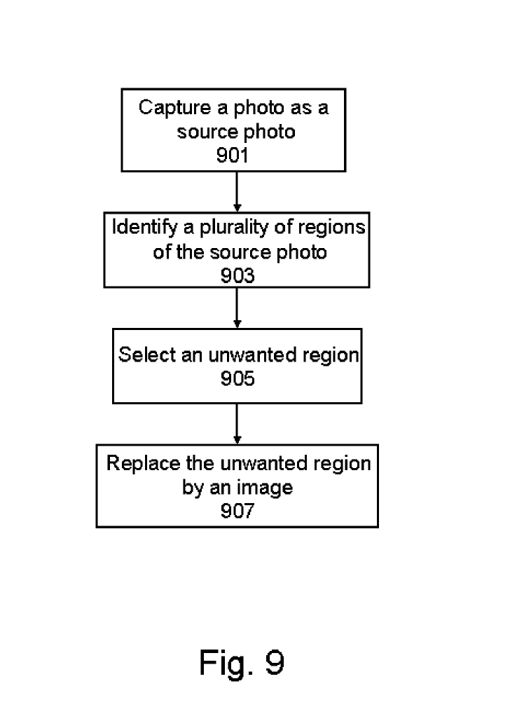

FIG. 8 shows a flow chart of a method for moving unwanted object of a photo taken by a digital camera according to this invention. The camera captures a plurality of photos as shown in step 801. The camera compares the captured photos as shown in step 803. The camera identifies a moving part of the photos according to the comparison result between the photos as shown in step 805. Choosing one of the plurality of photos as a source photo as shown in step 807. To be noted, the step 807 can move right after step 801 or right after step 803. In step 807, the choosing process can be made by automatically the camera or manually by the user. The camera replaces the moving part of the source photo by non-moving part of the other photo as shown in step 809. In some cases, the moving part is hard to be replaced by the other photo; the moving part can be replaced by surrounding background.

FIG. 9 shows a flow chart of a method for removing unwanted object of a photo taken by a digital camera according to this invention. The camera captures a photo as a source photo as shown in step 901. The camera identifies a plurality of regions of the source photo as shown in step 903. Each of the regions is corresponding to an object, such as a person, a car or a dog. The region can be defined by some well-known algorithms for photo; such as increasing the sharpness, identifying the contour etc. The user selects an unwanted region of these regions as shown in step 905. The digital camera replaces the unwanted region by an image as shown in step 907. As mentioned previously, the replacing image can be an image from a corresponding position of the unwanted region of another photo or an image interpolated by surrounding background of the replaced region. Furthermore, the replacing image can also be a mix with both a corresponding position of the unwanted region of another photo and a surrounding position of the unwanted region of another photo. In addition, the replacing image can be an image selected from a predetermined database, such as an animated figure image or a famous figure's image to replacing the unwanted object.

Those skilled in the art will readily observe that numerous modifications and alterations of the device and method may be made while retaining the teachings of the invention.

What is claimed is:

1. A photo processing method of a digital camera, comprising:
capturing a plurality of photos of a scene;
comparing the photos to identify a moving part of the photos;
choosing one of the plurality of photos as a source photo, replacing the moving part of the source photo according to a non-moving part of at least one of the photos; and
outputting the modified source photo.

2. The photo processing method of claim 1, wherein the non-moving part of the photos is a relatively steady part of the photos.

3. The photo processing method of claim 1, wherein the moving part or the non-moving part can be defined by a user.

4. The photo processing method of claim 1, further comprising:
defining a region of the photos by the digital camera or a user, and identifying the region as a subset of the non-moving part.

5. The photo processing method of claim 1, further comprising:
defining a region of the photos by the digital camera or a user, and identifying the region as a subset of the moving part.

6. The photo processing method of claim 1, wherein replacing the moving part of the source photo according to a non-moving part of at least one of the photos, is according to a non-moving part with a corresponding position of the replaced moving part.

7. The photo processing method of claim 1, wherein replacing the moving part of the source photo according to a non-moving part of at least one of the photos, is according to a non-moving part with a surrounding position of the replaced moving part.

8. A photo processing method of a digital camera, comprising:
capturing a source photo of a scene;
identifying a plurality of regions of the source photo, each region corresponding to an object of the scene;
selecting an unwanted region by a user; and
replacing the unwanted region by an image.

9. The photo processing method of claim 8, wherein the image is an image from a corresponding position of the unwanted region of another photo.

10. The photo processing method of claim 8, wherein the image is an interpolating image according to surrounding background information.

11. The photo processing method of claim 8, wherein the image is an image mix with both a corresponding position of the unwanted region of another photo and a surrounding position of the unwanted region of another photo.

12. The photo processing method of claim 8, wherein the image is an image of a predetermined database.

13. A digital camera for capturing a photo with removing unwanted object in the photo, comprising
a lenses and image sensor module, for capturing a plurality of photos;
a memory, for storing the plurality of photos;
a controller, for removing unwanted object in one of the plurality of photos, wherein, the controller compares the plurality of photos, identifies a moving part of the plurality of photos, chooses one of the plurality of photos as a source photo, removes the moving part of the photo and replaces the moving part by a non-moving part of at least one of the photos, and outputs the modified source photo.

14. The photo processing method of claim 13, wherein the non-moving part of the photo is a relatively steady part of the photo.

15. The photo processing method of claim 13, wherein the moving part or the non-moving part can be defined by a user.

16. The photo processing method of claim 13, further comprising:
defining a region of the photos by the digital camera or a user, and identifying the region as a subset of the non-moving part.

17. The photo processing method of claim 13, further comprising:
defining a region of the photos by the digital camera or a user, and identifying the region as a subset of the moving part.

18. The photo processing method of claim 13, wherein replacing the moving part of the source photo according to a non-moving part of at least one of the photos, is according to a non-moving part with a corresponding position of the replaced moving part.

19. The photo processing method of claim 13, wherein replacing the moving part of the source photo according to a non-moving part of at least one of the photos, is according to a non-moving part with a surrounding position of the replaced moving part.
